(19) United States
(12) Patent Application Publication
(10) Pub. No.: US 2024/0311884 A1
(43) Pub. Date: Sep. 19, 2024

(54) SYSTEMS AND METHODS FOR OWNERSHIP DETERMINATION

(71) Applicant: Honda Motor Co., Ltd., Tokyo (JP)

(72) Inventor: Matt KOMICH, Denver, CO (US)

(21) Appl. No.: 18/185,458

(22) Filed: Mar. 17, 2023

(51) Int. Cl. G06Q 30/0601

(52) U.S. Cl. CPC G06Q 30/0605

(57) ABSTRACT

Systems and methods for ownership determination are provided. In one embodiment, a method includes creating a listing for a pre-owned vehicle based on vehicle information from a prospective seller. The method includes identifying a first test drive of the pre-owned vehicle with a first user of a plurality of users scheduled during a test drive window. The method includes monitoring scheduling events for the pre-owned vehicle for a scheduling period after the test drive window. The method includes sending the first user an ownership notification in response to determining that no scheduling events have occurred during the scheduling period. The method includes receiving feedback from the first user based on the ownership notification. The method includes generating a new owner profile for the new owner that changes the initial settings of the one or more vehicle systems to subsequent settings that alter the operation of the pre-owned vehicle.

### BACKGROUND

The global used car market size was valued at 1.57 trillion U.S. dollars in 2021 and is expected to expand at a compound annual growth rate of 6.1% from 2022 to 2030. The used car shipment was recorded at 120.3 million units in 2021. The market has witnessed significant growth in the last few years as the price competitiveness has been one glowing spot in the used car industry. Further, the role of online sales has become a critical growth factor in the market. Online sites in automotive marketplaces have played an essential role in bringing access to consumers with a single touch.

### BRIEF DESCRIPTION

In one embodiment, a system for ownership determination is provided that includes a processor and a memory storing instructions. When executed by the processor, the instructions cause the processor to create a listing for a pre-owned vehicle based on vehicle information from a prospective seller. The pre-owned vehicle includes one or more vehicle systems having initial settings for operation of the pre-owned vehicle. The instructions also cause the processor to identify a first test drive of the pre-owned vehicle with a first user of a plurality of users scheduled for a test drive window. The instructions further cause the processor to monitor scheduling events for the pre-owned vehicle for a scheduling period after the test drive window. A scheduling event is an interaction between a user of the plurality of users and the pre-owned vehicle. The instructions yet further cause the processor to send the first user an ownership notification in response to determining that no scheduling events have occurred during the scheduling period. The instructions cause the processor to receive feedback from the first user based on the ownership notification. The feedback identifies the first user as a new owner of the pre-owned vehicle. The instructions also cause the processor to generate a new owner profile for the new owner that changes the initial settings of the one or more vehicle systems to subsequent settings that alter the operation of the pre-owned vehicle.

In another embodiment, a method for ownership determination is provided. The method includes creating a listing for a pre-owned vehicle based on vehicle information from a prospective seller. The method also includes identifying a first test drive of the pre-owned vehicle with a first user of a plurality of users scheduled for a test drive window. The method further includes monitoring scheduling events for the pre-owned vehicle for a scheduling period after the test drive window. A scheduling event is an interaction between a user of the plurality of users and the pre-owned vehicle. The method yet further includes sending the first user an ownership notification in response to determining that no scheduling events have occurred during the scheduling period.

In yet another embodiment, a non-transitory computer readable storage medium storing instructions that when executed by a computer having a processor to perform a method for ownership determination is provided. The method includes creating a listing for a pre-owned vehicle based on vehicle information from a prospective seller. The pre-owned vehicle includes one or more vehicle systems having initial settings for operation of the pre-owned vehicle. The method also includes identifying a first test drive of the pre-owned vehicle with a first user of a plurality of users scheduled for a test drive window. The method further includes monitoring scheduling events for the pre-owned vehicle for a scheduling period after the test drive window. A scheduling event is an interaction between a user of the plurality of users and the pre-owned vehicle. The method yet further includes sending the first user an ownership notification in response to determining that no scheduling events have occurred during the scheduling period. The method includes receiving feedback from the first user based on the ownership notification. The feedback identifies the first user as a new owner of the pre-owned vehicle. The method also includes generating a new owner profile for the new owner that changes the initial settings of the one or more vehicle systems to subsequent settings that alter the operation of the pre-owned vehicle.

### BRIEF DESCRIPTION OF THE DRAWINGS

FIG. 1 is an exemplary component diagram of a system for ownership determination, according to one aspect.

FIG. 2 is an exemplary pre-owned vehicle for sale in an automotive marketplace, according to one aspect.

FIG. 3 is an exemplary process flow of a method for ownership determination, according to one aspect.

FIG. 4 is an exemplary process flow of another method for ownership determination, according to one aspect.

FIG. 5 is an exemplary process flow of yet a further method of ownership determination, according to one aspect.

FIG. 6 is an illustration of an example computer-readable medium or computer-readable device including processor-executable instructions configured to embody one or more of the provisions set forth herein, according to one aspect.

### DETAILED DESCRIPTION

Technological advancements, such as the development of the internet and the introduction of online vehicle sales, have resulted in consumers becoming more knowledgeable about the vehicle, a vehicle's residual value, finance charges, availability, and/or the profit margin that the seller makes in a closing deal for the vehicle. Accordingly, the platforms that facilitate private sales between individual buyers and sellers are growing in popularity. However, there is a limited opportunity for third party entities, such as vehicle manufacturers, to collect information regarding private sales, and specifically the identity of new owners. As vehicles are able to be increasingly tailored to individuals, this information may help the third party entities provide the best driving experience to a new owner.

To determine ownership, the third party entity may generate notifications for one or more users of an automotive marketplace. The notifications may be triggered based on one or more events that occur between a prospective seller and a user in the automotive marketplace based on a listing of a vehicle. The events may include the prospective seller scheduling test drives of the vehicle with one or more users. The events may also include the prospective seller actively changing the status of the listing. For example, the prospective seller altering the listing of the vehicle to indicate that the vehicle is sold or give the vehicle an unavailable status. The events may also include passive changes to the listing. For example, if the prospective seller does not schedule test drives for the vehicle or update the listing, the listing may be deemed inactive after an inactivity window of time has elapsed. In this manner, events occurring in the automotive marketplace may trigger a third party to generate a notification to determine if ownership of the vehicle has changed.

### Definitions

The following includes definitions of selected terms employed herein. The definitions include various examples and/or forms of components that fall within the scope of a term and that may be used for implementation. The examples are not intended to be limiting. Furthermore, the components discussed herein, may be combined, omitted, or organized with other components or into different architectures.

“Bus,” as used herein, refers to an interconnected architecture that is operably connected to other computer components inside a computer or between computers. The bus may transfer data between the computer components. The bus may be a memory bus, a memory processor, a peripheral bus, an external bus, a crossbar switch, and/or a local bus, among others. The bus may also be a bus that interconnects components inside an agent using protocols such as Media Oriented Systems Transport (MOST), Controller Area network (CAN), Local Interconnect network (LIN), among others.

“Component,” as used herein, refers to a computer-related entity (e.g., hardware, firmware, instructions in execution, combinations thereof). Computer components may include, for example, a process running on a processor, a processor, an object, an executable, a thread of execution, and a computer. A computer component(s) may reside within a process and/or thread. A computer component may be localized on one computer and/or may be distributed between multiple computers.

“Computer communication,” as used herein, refers to a communication between two or more communicating devices (e.g., computer, personal digital assistant, cellular telephone, network device, vehicle, computing device, infrastructure device, roadside equipment) and may be, for example, a network transfer, a data transfer, a file transfer, an applet transfer, an email, a hypertext transfer protocol (HTTP) transfer, and so on. A computer communication may occur across any type of wired or wireless system and/or network having any type of configuration, for example, a local area network (LAN), a personal area network (PAN), a wireless personal area network (WPAN), a wireless network (WAN), a wide area network (WAN), a metropolitan area network (MAN), a virtual private network (VPN), a cellular network, a token ring network, a point-to-point network, an ad hoc network, a mobile ad hoc network, a vehicular ad hoc network (VANET), a vehicle-to-vehicle (V2V) network, a vehicle-to-everything (V2X) network, a vehicle-to-infrastructure (V2I) network, among others. Computer communication may utilize any type of wired, wireless, or network communication protocol including, but not limited to, Ethernet (e.g., IEEE 802.3), WiFi (e.g., IEEE 802.11), communications access for land mobiles (CALM), WiMax, Bluetooth, Zigbee, ultra-wideband (UWAB), multiple-input and multiple-output (MIMO), telecommunications and/or cellular network communication (e.g., SMS, MMS, 3G, 4G, LTE, 5G, GSM, CDMA, WAVE), satellite, dedicated short range communication (DSRC), among others.

“Communication interface” as used herein may include input and/or output devices for receiving input and/or devices for outputting data. The input and/or output may be for controlling different agent features, which include various agent components, systems, and subsystems. Specifically, the term “input device” includes, but is not limited to: keyboard, microphones, pointing and selection devices, cameras, imaging devices, video cards, displays, push buttons, rotary knobs, and the like. The term “input device” additionally includes graphical input controls that take place within a user interface which may be displayed by various types of mechanisms such as software and hardware-based controls, interfaces, touch screens, touch pads or plug and play devices. An “output device” includes, but is not limited to, display devices, and other devices for outputting information and functions.

“Computer-readable medium,” as used herein, refers to a non-transitory medium that stores instructions and/or data. A computer-readable medium may take forms, including, but not limited to, non-volatile media, and volatile media. Non-volatile media may include, for example, optical disks, magnetic disks, and so on. Volatile media may include, for example, semiconductor memories, dynamic memory, and so on. Common forms of a computer-readable medium may include, but are not limited to, a floppy disk, a flexible disk, a hard disk, a magnetic tape, other magnetic medium, an ASIC, a CD, other optical medium, a RAM, a ROM, a memory chip or card, a memory stick, and other media from which a computer, a processor or other electronic device may read.

“Database,” as used herein, is used to refer to a table. In other examples, “database” may be used to refer to a set of tables. In still other examples, “database” may refer to a set of data stores and methods for accessing and/or manipulating those data stores. In one embodiment, a database may be stored, for example, at a disk, data store, and/or a memory. A database may be stored locally or remotely and accessed via a network.

“Data store,” as used herein may be, for example, a magnetic disk drive, a solid-state disk drive, a floppy disk drive, a tape drive, a Zip drive, a flash memory card, and/or a memory stick. Furthermore, the disk may be a CD-ROM (compact disk ROM), a CD recordable drive (CD-R drive), a CD rewritable drive (CD-RW drive), and/or a digital video ROM drive (DVD ROM). The disk may store an operating system that controls or allocates resources of a computing device.

“Display,” as used herein may include, but is not limited to, LED display panels, LCD display panels, CRT display, touch screen displays, among others, that often display information. The display may receive input (e.g., touch input, keyboard input, input from various other input devices, etc.) from a user. The display may be accessible through various devices, for example, though a remote system. The display may also be physically located on a portable device, mobility device, or host.

“Logic circuitry,” as used herein, includes, but is not limited to, hardware, firmware, a non-transitory computer readable medium that stores instructions, instructions in execution on a machine, and/or to cause (e.g., execute) an action(s) from another logic circuitry, module, method and/or system. Logic circuitry may include and/or be a part of a processor controlled by an algorithm, a discrete logic (e.g., ASIC), an analog circuit, a digital circuit, a programmed logic device, a memory device containing instructions, and so on. Logic may include one or more gates, combinations of gates, or other circuit components. Where multiple logics are described, it may be possible to incorporate the multiple logics into one physical logic. Similarly, where a single logic is described, it may be possible to distribute that single logic between multiple physical logics.

“Memory,” as used herein may include volatile memory and/or non-volatile memory. Non-volatile memory may include, for example, ROM (read only memory), PROM (programmable read only memory), EPROM (erasable PROM), and EEPROM (electrically erasable PROM). Volatile memory may include, for example, RAM (random access memory), synchronous RAM (SRAM), dynamic RAM (DRAM), synchronous DRAM (SDRAM), double data rate SDRAM (DDRSDRAM), and direct RAM bus RAM (DRRAM). The memory may store an operating system that controls or allocates resources of a computing device.

“Module,” as used herein, includes, but is not limited to, non-transitory computer readable medium that stores instructions, instructions in execution on a machine, hardware, firmware, software in execution on a machine, and/or combinations of each to perform a function(s) or an action(s), and/or to cause a function or action from another module, method, and/or system. A module may also include logic, a software-controlled microprocessor, a discrete logic circuit, an analog circuit, a digital circuit, a programmed logic device, a memory device containing executing instructions, logic gates, a combination of gates, and/or other circuit components. Multiple modules may be combined into one module and single modules may be distributed among multiple modules.

“Operable connection,” or a connection by which entities are “operably connected,” is one in which signals, physical communications, and/or logical communications may be sent and/or received. An operable connection may include a wireless interface, firmware interface, a physical interface, a data interface, and/or an electrical interface.

“Portable device,” as used herein, is a computing device typically having a display screen with user input (e.g., touch, keyboard) and a processor for computing. Portable devices include, but are not limited to, handheld devices, mobile devices, smart phones, laptops, tablets, e-readers, smart speakers. In some embodiments, a “portable device” could refer to a remote device that includes a processor for computing and/or a communication interface for receiving and transmitting data remotely.

“Processor,” as used herein, processes signals and performs general computing and arithmetic functions. Signals processed by the processor may include digital signals, data signals, computer instructions, processor instructions, messages, a bit, a bit stream, that may be received, transmitted and/or detected. Generally, the processor may be a variety of various processors including multiple single and multicore processors and co-processors and other multiple single and multicore processor and co-processor architectures. The processor may include logic circuitry to execute actions and/or algorithms.

“Vehicle,” as used herein, refers to any moving vehicle that is capable of carrying one or more users and is powered by any form of energy. The term “vehicle” includes, but is not limited to cars, trucks, vans, minivans, SUVs, motorcycles, scooters, boats, go-karts, amusement ride cars, rail transport, personal watercraft, and aircraft. Further, the term “vehicle” may refer to an electric vehicle (EV) that is powered entirely or partially by one or more electric motors powered by an electric battery. The EV may include battery electric vehicles and plug-in hybrid electric vehicles (PHEV). The term “vehicle” may also refer to an autonomous vehicle and/or self-driving vehicle powered by any form of energy.

A “vehicle system,” as used herein may include, but is not limited to, any automatic or manual systems that may be used to enhance the vehicle, driving, and/or operation. Exemplary vehicle systems include, but are not limited to: an electronic stability control system, an anti-lock brake system, a brake assist system, an automatic brake prefill system, a low speed follow system, a cruise control system, an auto cruise control system, a lane departure warning system, a blind spot indicator system, a lane keep assist system, a navigation system, a transmission system, brake pedal systems, an electronic power steering system, visual devices (e.g., camera systems, proximity sensor systems), a climate control system, an electronic pretensioning system, a monitoring system, a passenger detection system, a vehicle suspension system, a vehicle seat configuration system, a vehicle cabin lighting system, an audio system, a sensory system, among others.

### I. System Overview

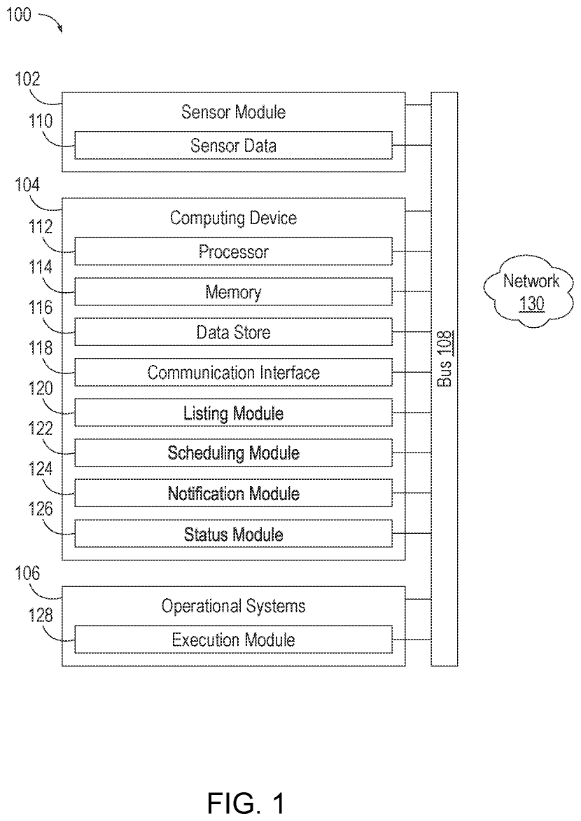

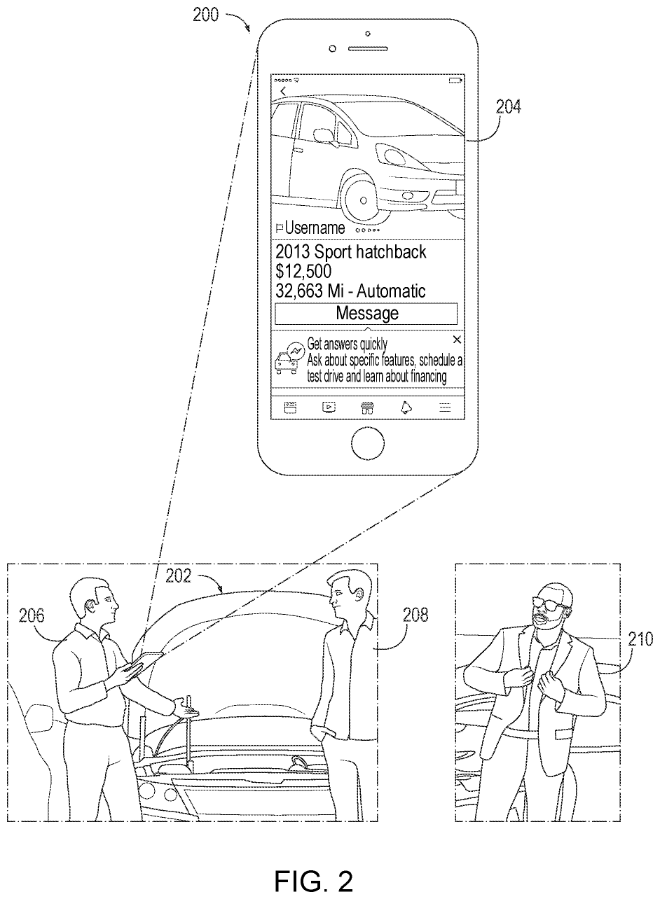

Referring now to the drawings, the drawings are for purposes of illustrating one or more exemplary embodiments and not for purposes of limiting the same. FIG. 1 is an exemplary component diagram of an operating environment 100 for trajectory imputation and prediction, according to one aspect. The operating environment 100 includes a sensor module 102, a computing device 104, and operational systems 106 interconnected by a bus 108. The components of the operating environment 100, as well as the components of other systems, hardware architectures, and software architectures discussed herein, may be combined, omitted, or organized into different architectures for various embodiments. The computing device 104 may be implemented with a device or remotely stored. For example, the components and functions of the computing device 104 may be implemented with a portable device 200, shown in FIG. 2, or another device connected via a network (e.g., a network 130).

In another embodiment, the computing device 104 may be implemented as a part of an ego agent, such as the pre-owned vehicle 202, shown in FIG. 2. For example, the computing device 104 may be implemented as part of a telematics unit, a head unit, a navigation unit, an infotainment unit, an electronic control unit, among others of the ego agent. For clarity, the ego agent in the embodiments described herein will be referred to as the pre-owned vehicle 202 but may be another type of vehicle or agent, such as a robotic device.

The computing device 104 may be capable of providing wired or wireless computer communications utilizing various protocols to send and/or receive electronic signals internally to/from components of the operating environment 100. Additionally, the computing device 104 may be operably connected for internal computer communication via the bus 108 (e.g., a Controller Area Network (CAN) or a Local Interconnect Network (LIN) protocol bus) to facilitate data input and output between the computing device 104 and the components of the operating environment 100, such as the sensor module 102 and/or the operational systems 106.

The pre-owned vehicle 202 may include sensors for sensing objects and position. For example, the pre-owned vehicle 202 may include an image sensor (not shown). The image sensor may be a light sensor to capture light data from around the pre-owned vehicle 202. For example, a light sensor may rotate 360 degrees around pre-owned vehicle 202 and collect the sensor data 110 in sweeps. Conversely, an image sensor may be omnidirectional and collect sensor data 110 from all directions simultaneously. The image sensor may positioned on the pre-owned vehicle 202. For example, suppose that the pre-owned vehicle 202 is a vehicle. One or more sensors may be positioned at external front and/or side portions of the pre-owned vehicle 202, including, but not limited to different portions of the vehicle bumper, vehicle front lighting units, vehicle fenders, and the windshield. Additionally, the sensors may be disposed at internal portions of the pre-owned vehicle 202 including the vehicle dashboard (e.g., dash mounted camera), rear side of a vehicle rear view mirror, etc. Sensors may be positioned on a planar sweep pedestal (not shown) that allows the image sensor to be rotated to capture images of the environment at various angles.

Accordingly, the sensors, such as the image sensor, and/or the sensor module 102 are operable to sense a measurement of data associated with the pre-owned vehicle 202, the operating environment 100, and/or the operational systems 106 and generate a data signal indicating said measurement of data. These data signals may be converted into other data formats (e.g., numerical) and/or used by the sensor module 102, the computing device 104, and/or the operational systems 106 to generate sensor data 110 including data metrics and parameters.

The computing device 104 includes a processor 112, a memory 114, a data store 116, and a communication interface 118, which are each operably connected for computer communication via a bus 108 and/or other wired and wireless technologies. The communication interface 118 provides software and hardware to facilitate data input and output between the components of the computing device 104 and other components, networks, and data sources, which will be described herein. Additionally, the computing device 104 also includes a listing module 120, a scheduling module 122, a notification module 124, and a status module 126 facilitated by the components of the operating environment 100.

In one embodiment, the processor 112 may store application frameworks, kernels, libraries, drivers, application program interfaces, among others, to execute and control hardware and functions discussed herein. For example, the processor 112 may include the listing module 120, the scheduling module 122, the notification module 124, and the status module 126 although it is understood that the processor 112 may be configured into other architectures. For example, the listing module 120, the scheduling module 122, the notification module 124, and the status module 126 may be artificial neural networks that act as a framework for machine learning, including deep reinforcement learning, such as a convolution neural network.

The computing device 104 is also operably connected for computer communication (e.g., via the bus 108 and/or the communication interface 118) to one or more operational systems 106. The operational systems 106 may include, but are not limited to, any automatic or manual systems that may be used to enhance the pre-owned vehicle 202, operation, and/or propulsion such as agent systems or vehicle systems. The operational systems 106 include an execution module 128. The execution module 128 monitors, analyses, and/or operates the pre-owned vehicle 202, to some degree. For example, the execution module 128 may store, calculate, and provide information to the vehicle systems of the pre-owned vehicle 202. In one embodiment, the execution module 128 may cause a display (not shown) of an infotainment system to display a message or a notification. In this manner, the execution module 128 may provide operational data to vehicle systems dependent on the implementation. The operational systems 106 also include and/or are operably connected for computer communication to the sensor module 102.

The portable device 200 and the pre-owned vehicle 202 may also operatively connected for computer communication to the network 130, and any remote systems (not shown). It is understood that the connection from the communication interface 118 to the network 130, portable device 200 and the pre-owned vehicle 202 may be facilitated in various ways. For example, through a network connection (e.g., wired or wireless), a cellular data network from the portable device 200, etc.

The sensor module 102, the computing device 104, and/or the operational systems 106 are also operatively connected for computer communication to the network 130. The network 130 is, for example, a data network, the Internet, a wide area network (WAN) or a local area (LAN) network. The network 130 serves as a communication medium to various remote devices (e.g., databases, web servers, remote servers, application servers, intermediary servers, client machines, other portable devices). Detailed embodiments describing exemplary methods using the system and network configuration discussed above will now be discussed in detail.

### II. Methods

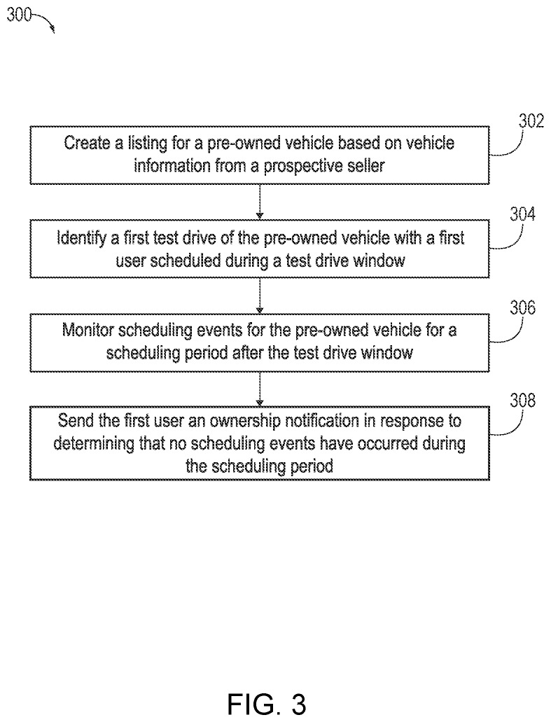

Referring now to FIG. 3, a method 300 for ownership determination will now be described according to an exemplary embodiment. FIG. 3 will also be described with reference to FIGS. 1, 2, and 4-6. For simplicity, the method 300 will be described as a sequence of blocks, but it is understood that the elements of the method 300 may be organized into different architectures, elements, stages, and/or processes.

At block 302, the method 300 includes the listing module 120 creating a listing 204 for a pre-owned vehicle 202 based on vehicle information from a prospective seller 206. The listing module 120 may generate the listing 204 in the automotive marketplace using the portable device 200. The automotive marketplace may be used to sell the pre-owned vehicle 202 from the prospective seller 206 to a user of the automotive marketplace. In this manner, the automotive marketplace facilitates transactions between private entities. For example, the prospective seller 206 may sell the pre-owned vehicle 202 to a first user 208 or a second user 210 through the automotive marketplace. While two users are described more or fewer user may utilize the automotive marketplace to buy a pre-owned vehicle 202. Likewise, while one prospective seller is discussed, the prospective seller 206, the automotive marketplace may host any number of prospective sellers at a given time.

In one embodiment, the listing module 120 may be accessed by way of the portable device 200 to create the listing 204 based on user input of the prospective seller 206 at the portable device 200. The prospective seller 206 may manually input vehicle information about the pre-owned vehicle 202 into the portable device 200 using an input device, such as a keypad, voice recognition, touch screen, etc. to create the listing 204. In some embodiments, the portable device 200 may run an application that allows the prospective seller 206 to interface with the listing module 120. The application may be instructions in execution on the portable device 200, firmware, software in execution on the portable device 200, and/or combinations of each to perform a function(s) or an action(s), and/or to cause a function or action from another module, method, and/or system. In another example, the prospective seller 206 may speak vocally list vehicle information to a smart speaker.

In some embodiments, the vehicle information may include vehicle history report, vehicle identification number, vehicle specifications (e.g. make, model, year, etc.) photos of the pre-owned vehicle 202, a listing description about the pre-owned vehicle 202, a vehicle price for the pre-owned vehicle 202, vehicle mileage, a test drive scheduler, a test drive map, and an intra-platform chat, among others. The vehicle information may be input using a fillable form. The listing module 120 may then extract the vehicle information from remote sources to create the listing 204.

The listing module 120 may also generate the listing 204 based on a seller profile associated with the prospective seller 206. The seller profile may include information (e.g., legal name, address, phone number, electronic mail address, etc.) about the prospective seller 206, as well as seller preferences, such as the preferred communication method of the prospective seller 206. The information from the seller profile may not be visible in the listing 204. Instead, the listing module 120 may select an area for a test drive map based on the address of the prospective seller 206 from the seller profile. In some embodiments, the seller profile may be used to verify the identity of the prospective seller 206 as a security measure. For example, the listing module 120 may determine if the prospective seller has previously sold the pre-owned vehicle 202. Thus, the listing module 120 may make a threshold determination as to whether the listing should be posted to the automotive marketplace.

The listing module 120 may generate the listing 204 based on other sources of information. For example, the listing module 120 may generate the listing 204 based on logistical factors from an electronic or online calendar or datebook of the prospective seller 206. For example, the listing 204 may include a test drive scheduler that indicates one or more dates and times that the prospective seller 206 is available. The listing module 120 may access the calendar of the prospective seller 206 on a remote system to determine if the prospective seller 206 is available and is able to attend test drive based on events (e.g. appointment, meeting, date, party, etc.) and/or one or more additional logistical factors that indicate the ability of the prospective seller 206 to travel to a location.

At block 304, the method 300 includes the scheduling module 122 identifying a first test drive of the pre-owned vehicle 202 with a first user 208 of a plurality of users scheduled during a test drive window. As discussed above, the automotive marketplace may include the first user 208 and the second user 210 in the plurality of users. The scheduling module 122 schedules the pre-owned vehicle 202 to provide the first user 208 and/or the second user 210 with an opportunity to physically interact with the pre-owned vehicle 202. The pre-owned vehicle 202 may be scheduled based on the listing 204, seller preferences, and/or the seller profile, as well as availability. The scheduling module 122 may receive a request for a test drive from the first user 208 and confirm availability with the prospective seller 206.

The scheduling module 122 may schedule the test drives for a test drive window. The test drive window is a period of time that the prospective seller 206 is available to provide the pre-owned vehicle 202 to a user for a specific test drive. For example, if the first user 208 requests a first test drive at a first time on a first date, then the test drive window may include a predetermined amount of time before the first time, and expected length of time of the first test drive starting at the first time, and a predetermined amount of time after the expected length of time. Thus, the test drive window encapsulates the amount of time that the first test drive is expected to take including time before and after to account for flexibility, for example, if the first user 208 is late to the test drive, traffic is encountered during the first test drive, etc. In another embodiment, the prospective seller 206 may set the test drive window.

At block 306, the method 300 includes the scheduling module 122 monitoring scheduling events for the pre-owned vehicle 202 vehicle for a scheduling period after the test drive window. The scheduling period is an amount of time after the test drive window that the scheduling module 122 may monitor listing activity for the listing 204, such as scheduling additional test drives. The scheduling period may be based on the availability of the prospective seller 206 to provide the pre-owned vehicle 202 for test drives. The availability of the prospective seller 206 may not reflect that the prospective seller 206 is completely available, but rather include a number of times that the prospective seller 206 is available. The scheduling period may be a number of days that the prospective seller 206 is able to be available, such as a weekend or week. The scheduling period may be determined based on the availability of the prospective seller 206 from a remote source, such as the calendar of the prospective seller 206. The scheduling period may be an amount of time that prospective seller 206 wants the listing 204 to remain active on the automotive marketplace. In another embodiment, the scheduling module 122 may be a predetermined amount of time that is an average amount of time in which pre-owned vehicles typically sell on the automotive marketplace.

A scheduling event is an interaction between a user of the plurality of users and the pre-owned vehicle. The scheduling module 122 may attempt to satisfy multiple requests for test drives from a number of users from the plurality of users. The test drives may be scheduled during the scheduling period based on when the requests are received, the availability of the prospective seller, etc. For example, the scheduling module 122 may schedule a first test drive for the first user 208 for a first test drive window. The scheduling module 122 may schedule a second test drive for the second user 210 for a second test drive window, after the first test drive window but during the scheduling period. For example, if the first test drive is scheduled on a Saturday and the scheduling period is a week, then the second test drive being scheduled for Sunday would have the second test drive window scheduled within the scheduling period. If the second test drive was requested and scheduled for the following week, then the second test drive window would be scheduled after the scheduling period has lapsed.

The scheduling module 122 monitor listing activity for the listing 204 of the pre-owned vehicle 202 to determine if the pre-owned vehicle 202 has been further scheduled. The monitoring may begin when the test drive window lapses. The scheduling module 122 may monitor scheduling activity via a test drive scheduler or from a remote source such as the calendar of the prospective seller 206.

At block 308, the method 300 includes the notification module 124 sending the first user 208 an ownership notification in response to determining that no scheduling events have occurred during the scheduling period. For example, the ownership notification may include a request for user information from the first user 208. The user information may include a legal name of the first user 208, residential address, phone number, electronic mail address, etc. The ownership notification may request test drive information about the first test drive including user content (e.g., post, update, status, tweet, image, video, live feed, etc.) that the first user 208 may post to one or more social media platforms. Social media platforms comprise a plurality of individual user accounts for publishing and delivery of their user content to numerous recipients (e.g., friends, followers, etc.).

The ownership notification may request confirmation of whether the first user 208 has purchased the pre-owned vehicle 202. Additionally or alternatively, the ownership notification may request sale information regarding the sale of the pre-owned vehicle 202, such as whether the first user 208 has made an offer for the pre-owned vehicle, the amount of the offer, whether the offer was accepted, etc. The ownership notification may also request marketplace information from the first user that describes other activity the first user 208 may have conducted in the automotive marketplace, such as other vehicles that the first user 208 has test driven.

Accordingly, a prospective seller 206 may offer a pre-owned vehicle for sale in a private transaction in an automotive marketplace, and the notification module 124 can request confirmation of the identity of a prospective buyer, here the first user 208, based on the first test drive being scheduled without any subsequent test drives being scheduled in the scheduling period. Thus, if a test drive of the pre-owned vehicle 202 occurs, with non-scheduling of the pre-owned vehicle 202 after the test drive, the user that conducted the test drive may be sent an ownership notification.

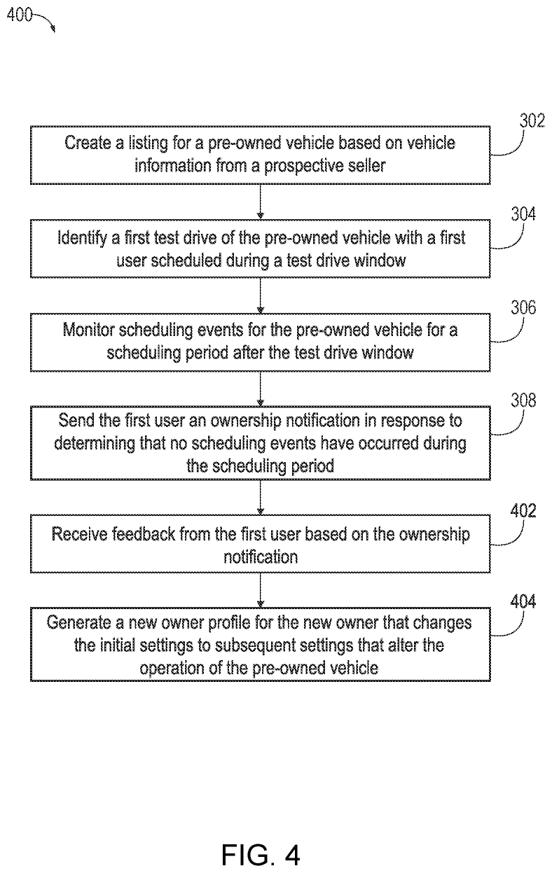

Referring now to FIG. 4, a method 400 for ownership determination will now be described according to an exemplary embodiment. FIG. 4 will also be described with reference to FIGS. 1, 2, and 4-6. In particular, elements 302-308 of the method 400 correspond to elements 302-308 of the method 300 and operate in a similar manner as described above with respect to FIG. 3. For simplicity, the method 400 will be described as a sequence of blocks, but it is understood that the elements of the method 400 may be organized into different architectures, elements, stages, and/or processes.

At block 302, the method 400 includes the listing module 120 creating a listing for the pre-owned vehicle 202 based on vehicle information from the prospective seller 206. At block 304, the method 400 includes the scheduling module 122 identifying a first test drive of the pre-owned vehicle 202 with a first user 208 of a plurality of users scheduled during a test drive window. The pre-owned vehicle 202 may include one or more vehicle systems having initial settings for operation of the pre-owned vehicle 202.

At block 306, the method 400 includes the scheduling module 122 monitoring scheduling events for the pre-owned vehicle 202 for a scheduling period after the test drive window. As discussed above, a scheduling event is an interaction between a user of the plurality of users and the pre-owned vehicle 202. At block 308, the method 400 includes the notification module 124 sending the first user 208 an ownership notification in response to determining that no scheduling events have occurred during the scheduling period.

At block 402, the method 400 includes the notification module 124 receiving feedback from the first user 208 based on the ownership notification. The feedback may identify the first user 208 as a new owner of the pre-owned vehicle 202. The feedback may include the sale information as well as the user information about the first user 208. The feedback may be received as answers to survey associated with the automotive marketplace or a third party entity. The feedback is received at the notification module 124 via the network 130 and may be stored in the memory 114 and/or the data store 116.

At block 404, the method 400 includes the execution module 128 generating a new owner profile for the new owner that changes the initial settings of the one or more vehicle systems to subsequent settings that alter the operation of the pre-owned vehicle 202. For example, the initial settings may include the preferences of the prospective seller 206 such as, driving style preferences (e.g., aggressive, defensive, etc.) and infotainment settings, (e.g., device connectivity settings, radio presets, etc.), among others.

In one embodiment, the notification module 124 nay cause the infotainment system to generate a profile notification for a new owner profile. The new owner profile may be generated with subsequent settings for the new owner and may be based on the user information of the first user 208. For example, the subsequent settings may be imported from a previous vehicle of the first user 208. The previous vehicle of the first user 208 may be identified in the feedback from the first user 208. In another embodiment, the subsequent settings may restore the vehicle systems of the pre-owned vehicle 202 to default settings. The default settings may cause the infotainment system of the vehicle systems to display a new owner message allowing the new owner to personalize the pre-owned vehicle 202 based on the preferences of the new owner. In this manner, the subsequent settings of the one or more vehicle systems alter the operation of the pre-owned vehicle 202.

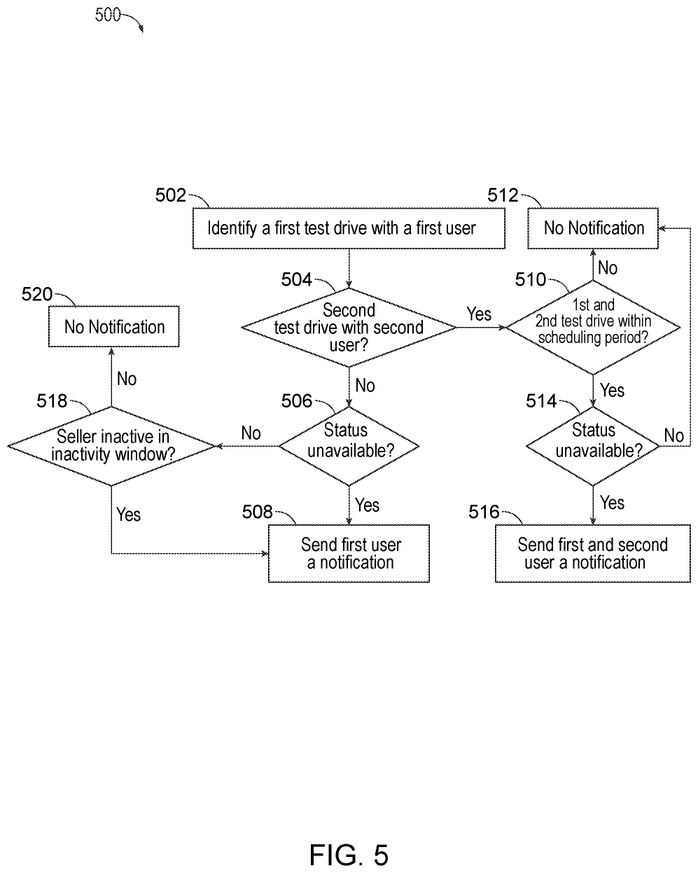

Referring now to FIG. 5, a method 500 for ownership determination will now be described according to an exemplary embodiment. FIG. 5 will also be described with reference to FIGS. 1-6. For simplicity, the method 500 will be described as a sequence of blocks, but it is understood that the elements of the method 500 may be organized into different architectures, elements, stages, and/or processes.

At block 502, the method 500 includes identifying a first test drive of the pre-owned vehicle 202 with a first user 208. As described with respect to block 302 of FIG. 3, the scheduling module 122 may identify that a first test drive has been scheduled by scheduling the first drive, for example, using a test drive scheduler associated with the listing 204 or from a remote source, such as calendar of the prospective seller 206.

At block 504, the method 500 includes the scheduling module 122 determining if a second test drive with a second user 210 has been scheduled. As with the first test drive, the second drive may be determined based on a test drive scheduler associated with the listing 204 or from a remote source, such as calendar of the prospective seller 206.

If no at block 504 and a second test drive with the second user 210 has not been scheduled, the method 500 moves to block 506. At block 506, a status module 126 determines if the status of the pre-owned vehicle 202 is unavailable. The status of the pre-owned vehicle 202 may identify the pre-owned vehicle 202 in the listing 204 is still available for purchase or unavailable for purchase through the automotive marketplace. For example, during the test drive window, the status of the pre-owned vehicle 202 may be an available status. Later, after the test drive window has lapsed, the status of the pre-owned vehicle 202 may be an unavailable status if the prospective seller 206 has marked the pre-owned vehicle 202 as “sold” with a sold indication in the listing 204.

If yes at block 506 and the status of the pre-owned vehicle 202 has been changed to unavailable, the method 500 moves to block 508. At block 508, the notification module 124 is triggered to send an ownership notification to the first user 208. As described above with respect to block 308, the ownership notification may include a request for user information from the first user 208, test drive information about the first test drive, and/or sale information to determine if the pre-owned vehicle 202 has been sold to the first user 208. Thus, if the prospective seller 206 and the first user 208 schedule a test drive of the pre-owned vehicle 202 and the prospective seller 206 later indicates that the pre-owned vehicle 202 is unavailable without scheduling another test drive with another user, the notification module 124 is triggered to send the ownership notification to the first user.

Returning to block 504, if yes and a second test drive with the second user 210 has been scheduled, the method 500 moves to block 510. At block 510 it is determined whether the first test drive of the first user 208 and the second test drive of the second user 210 have been scheduled within the scheduling period. The scheduling module 122 may determine if the first test drive and the second test drive have been scheduled during the scheduling period based on monitoring scheduling activity via a test drive scheduler or from a remote source such as the calendar of the prospective seller 206.

If no at block 510 and the second test drive has not been scheduled within the scheduling period, the method 500 moves to block 512. At block 512, the notification module 124 is not triggered and an ownership notification is not sent to the first user 208 or the second user 210.

If yes at block 510 and the second test drive was scheduled within the scheduling period, the method 500 moves to block 514. At block 514, the status module 126 determines if the status of the pre-owned vehicle 202 is unavailable. The status of the pre-owned vehicle 202 as an available status or an unavailable status may identify the pre-owned vehicle 202 in the listing 204 is still available for purchase or unavailable, respectively, for purchase through the automotive marketplace. For example, the status of the pre-owned vehicle 202 may be an unavailable status if the prospective seller 206 has marked the pre-owned vehicle 202 as “sold” in the listing 204 with a sold indication. In this manner, the status module 126 may determine if the status of the pre-owned vehicle 202 has changed from “for sale” to “sold.”

If no at block 514 and the status module 126 does not determine that the status of the pre-owned vehicle 202 is unavailable, then the method 500 returns to block 512. At block 512, the notification module 124 is not triggered and an ownership notification is not sent to the first user 208 or the second user 210. Thus, if the prospective seller 206 and the first user 208 schedule a first test drive and later, after the scheduling period, a second drive is scheduled with a second user 210, the notification module 124 is not triggered. Accordingly, the triggering event may be based on an assumption that the prospective seller did not move forward with a sale of the pre-owned vehicle 202.

If yes at block 514 and the status module 126 does determine that the status of the pre-owned vehicle 202 is unavailable, then the method 500 moves to block 516. At block 516, notification module 124 is triggered to send an ownership notification to both the first user 208 and the second user 210. Accordingly, the notification module 124 may send an ownership notification to multiple users of the plurality of user. The ownership notification may include a request for user information from the first user 208 and the second user 210, test drive information about the first test drive and/or the second test drive, and/or sale information to determine if the pre-owned vehicle 202 has been sold to the first user 208 or the second user 210. Accordingly, if the prospective seller 206 schedules multiple test-drives within the scheduling period but for different test drive windows, then the prospective seller 206 later marks the pre-owned vehicle 202 as unavailable, the notification module 124 is triggered to send ownership notifications to multiple users.

Returning to block 506, if at block 506 the pre-owned vehicle 202 is not marked as unavailable, the method 500 proceeds to block 518. At block 518, the status module 126 determines if the listing 204 has become inactive. For example, the status module 126 may determine if the prospective seller 206 has not taken any listing activity such as setting scheduling events (e.g., setting scheduling events) or making any changes to the status of the listing 204 (e.g., indicating that the pre-owned vehicle 202 is unavailable) during an inactivity period. The inactivity period is a predetermined amount of time after the test drive window. The inactivity period is at least as long as the scheduling period. The inactivity period may be restarted after any listing activity of the prospective seller 206 with respect to the pre-owned vehicle 202 and/or the listing 204. For example, the inactivity period may be two weeks from the test drive window. If the prospective seller 206 updates the listing 204, the inactivity period may be restarted from the time of update, and therefore, extend two weeks from the time of the update.

If the prospective seller 206 acts during the inactivity period, the method 500 proceeds to block 520 and the notification module 124 is not triggered and an ownership notification is not sent to the first user 208.

If the inactivity period lapses without any action by the prospective seller 206, the method 500 proceeds to block 508 and the notification module 124 is triggered to send an ownership notification to the first user 208. As described above with respect to block 308, the ownership notification may include a request for user information from the first user 208, test drive information about the first test drive, and/or sale information to determine if the pre-owned vehicle 202 has been sold to the first user 208. Thus, if the prospective seller 206 schedules a test drive with the first user 208 and then the listing 204 becomes inactive in the automotive marketplace for the inactivity period, the notification module 124 is triggered to send an ownership notification to the last user, here the first user 208, that scheduled a test drive. Accordingly, the systems and methods described herein are used to automatically trigger communications with users that are new owners. In this manner, a third-party entity associated with the automotive marketplace, such as vehicle manufacturers, may collect information regarding private sales, and specifically the identity of new owners. This information may help the third party entities provide the best driving experience of the pre-owned vehicle 202 to a new owner.

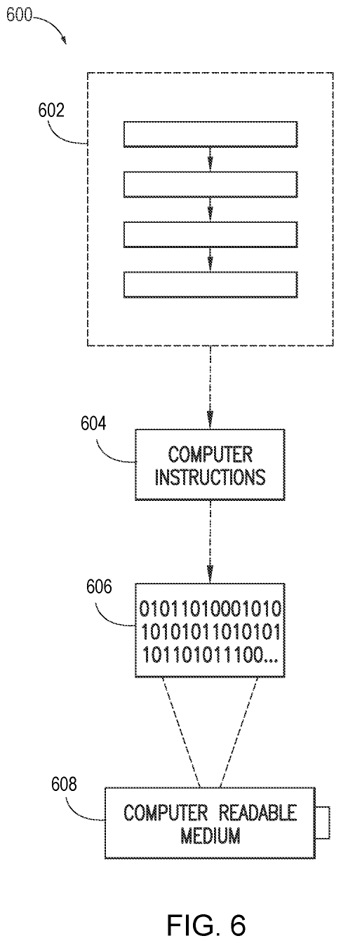

Still another aspect involves a computer-readable medium including processor-executable instructions configured to implement one aspect of the techniques presented herein. An aspect of a computer-readable medium or a computer-readable device devised in these ways is illustrated in FIG. 6, wherein an implementation 600 includes a computer-readable medium 608, such as a CD-R, DVD-R, flash drive, a platter of a hard disk drive, etc., on which is encoded computer-readable data 606. This encoded computer-readable data 606, such as binary data including a plurality of zero's and one's as shown in 606, in turn includes a set of processor-executable computer instructions 604 configured to operate according to one or more of the principles set forth herein.

In this implementation 600, the processor-executable computer instructions 604 may be configured to perform a method 602, such as the method 300 of FIG. 3, the method 400 of FIG. 4, and/or the method 500 of FIG. 5. In another aspect, the processor-executable computer instructions 604 may be configured to implement a system, such as the operating environment 100 of FIG. 1. Many such computer-readable media may be devised by those of ordinary skill in the art that are configured to operate in accordance with the techniques presented herein.

As used in this application, the terms “component”, “module,” “system”, “interface”, and the like are generally intended to refer to a computer-related entity, either hardware, a combination of hardware and software, software, or software in execution. For example, a component may be, but is not limited to being, a process running on a processor, a processing unit, an object, an executable, a thread of execution, a program, or a computer. By way of illustration, both an application running on a controller and the controller may be a component. One or more components residing within a process or thread of execution and a component may be localized on one computer or distributed between two or more computers.

Further, the claimed subject matter is implemented as a method, apparatus, or article of manufacture using standard programming or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

Although the subject matter has been described in language specific to structural features or methodological acts, it is to be understood that the subject matter of the appended claims is not necessarily limited to the specific features or acts described above. Rather, the specific features and acts described above are disclosed as example aspects. Various operations of aspects are provided herein. The order in which one or more or all of the operations are described should not be construed as to imply that these operations are necessarily order dependent. Alternative ordering will be appreciated based on this description. Further, not all operations may necessarily be present in each aspect provided herein.

As used in this application, “or” is intended to mean an inclusive “or” rather than an exclusive “or”. Further, an inclusive “or” may include any combination thereof (e.g., A, B, or any combination thereof). In addition, “a” and “an” as used in this application are generally construed to mean “one or more” unless specified otherwise or clear from context to be directed to a singular form. Additionally, at least one of A and B and/or the like generally means A or B or both A and B. Further, to the extent that “includes”, “having”, “has”, “with”, or variants thereof are used in either the detailed description or the claims, such terms are intended to be inclusive in a manner similar to the term “comprising”.

Further, unless specified otherwise, “first”, “second”, or the like are not intended to imply a temporal aspect, a spatial aspect, an ordering, etc. Rather, such terms are merely used as identifiers, names, etc. for features, elements, items, etc. For example, a first channel and a second channel generally correspond to channel A and channel B or two different or two identical channels or the same channel. Additionally, “comprising”, “comprises”, “including”, “includes”, or the like generally means comprising or including, but not limited to.

It will be appreciated that several of the above-disclosed and other features and functions, or alternatives or varieties thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A system for ownership determination, comprising:
a processor; and
a memory storing instructions that when executed by the processor cause the processor to:
create a listing for a pre-owned vehicle based on vehicle information from a prospective seller, wherein the pre-owned vehicle includes one or more vehicle systems having initial settings for operation of the pre-owned vehicle;
identify a first test drive of the pre-owned vehicle with a first user of a plurality of users scheduled for a test drive window;
monitor scheduling events for the pre-owned vehicle for a scheduling period after the test drive window, wherein a scheduling event is an interaction between a user of the plurality of users and the pre-owned vehicle;
send the first user an ownership notification in response to determining that no scheduling events have occurred during the scheduling period;
receive feedback from the first user based on the ownership notification, wherein the feedback identifies the first user as a new owner of the pre-owned vehicle; and
generate a new owner profile for the new owner that changes the initial settings of the one or more vehicle systems to subsequent settings that alter the operation of the pre-owned vehicle.

2. The system of claim 1, wherein the instructions, when executed by the processor, further cause the processor to:
determine that a status of the listing has changed from an available status at the test drive window to an unavailable status after the test drive window, wherein sending the first user the ownership notification is further based on the unavailable status.

3. The system of claim 2, wherein the change to the unavailable status occurs in response to receiving a sold indication from the prospective seller.

4. The system of claim 2, wherein the instructions, when executed by the processor, further cause the processor to:
identify a second test drive of the pre-owned vehicle with a second user of the plurality of users is scheduled during the scheduling period; and
send the second user the ownership notification in response to determining that the status of the listing has changed.

5. The system of claim 1, wherein the instructions, when executed by the processor, further cause the processor to:
monitor listing activity for the listing by the prospective seller; wherein sending the first user the ownership notification is further based on determining that no listing activity has occurred during an inactivity period.

6. The system of claim 1, wherein the subsequent settings are imported from a previous vehicle of the new owner.

7. The system of claim 1, wherein the one or more vehicle systems include an infotainment system, and wherein the subsequent settings cause a display of the infotainment system to generate a profile notification for the new owner profile.

8. A method for ownership determination, comprising:
creating a listing for a pre-owned vehicle based on vehicle information from a prospective seller;
identifying a first test drive of the pre-owned vehicle with a first user of a plurality of users scheduled for a test drive window;
monitoring scheduling events for the pre-owned vehicle for a scheduling period after the test drive window, wherein a scheduling event is an interaction between a user of the plurality of users and the pre-owned vehicle; and
sending the first user an ownership notification in response to determining that no scheduling events have occurred during the scheduling period.

9. The method of claim 8, further comprising:
determining that a status of the listing has changed from an available status at the test drive window to an unavailable status after the test drive window, wherein sending the first user the ownership notification is further based on the unavailable status.

10. The method of claim 9, wherein the change to the unavailable status occurs in response to receiving a sold indication from the prospective seller.

11. The method of claim 9, further comprising:
identifying a second test drive of the pre-owned vehicle with a second user of the plurality of users is scheduled during the scheduling period; and
sending the second user the ownership notification in response to determining that the status of the listing has changed.

12. The method of claim 8, further comprising:
monitoring listing activity for the listing by the prospective seller; wherein sending the first user the ownership notification is further based on determining that no listing activity has occurred during an inactivity period.

13. The method of claim 8, wherein the pre-owned vehicle includes one or more vehicle systems having initial settings for operation of the pre-owned vehicle, the method further comprising:
receiving feedback from the first user based on the ownership notification, wherein the feedback identifies the first user as a new owner of the pre-owned vehicle; and
generating a new owner profile for the new owner that changes the initial settings to subsequent settings of the one or more vehicle systems that alter the operation of the pre-owned vehicle.

14. The method of claim 13, wherein the subsequent settings are imported from a previous vehicle of the first user.

15. A non-transitory computer readable storage medium storing instructions that when executed by a computer having a processor to perform a method for ownership determination, the method comprising:
creating a listing for a pre-owned vehicle based on vehicle information from a prospective seller, wherein the pre-owned vehicle includes one or more vehicle systems having initial settings for operation of the pre-owned vehicle;
identifying a first test drive of the pre-owned vehicle with a first user of a plurality of users scheduled for a test drive window;
monitoring scheduling events for the pre-owned vehicle for a scheduling period after the test drive window, wherein a scheduling event is an interaction between a user of the plurality of users and the pre-owned vehicle;
sending the first user an ownership notification in response to determining that no scheduling events have occurred during the scheduling period;
receiving feedback from the first user based on the ownership notification, wherein the feedback identifies the first user as a new owner of the pre-owned vehicle; and
generating a new owner profile for the new owner that changes the initial settings of the one or more vehicle systems to subsequent settings that alter the operation of the pre-owned vehicle.

16. The non-transitory computer readable storage medium storing instructions of claim 15, further comprising:
determining that a status of the listing has changed from an available status at the test drive window to an unavailable status after the test drive window, wherein sending the first user the ownership notification is further based on the unavailable status.

17. The non-transitory computer readable storage medium storing instructions of claim 16, wherein the change to the unavailable status occurs in response to receiving a sold indication from the prospective seller.

18. The non-transitory computer readable storage medium storing instructions of claim 16, further comprising:
identifying a second test drive of the pre-owned vehicle with a second user of the plurality of users is scheduled during the scheduling period; and
sending the second user the ownership notification in response to determining that the status of the listing has changed.

19. The non-transitory computer readable storage medium storing instructions of claim 15, further comprising:
monitoring listing activity for the listing by the prospective seller; wherein sending the first user the ownership notification is further based on determining that no listing activity has occurred during an inactivity period.

20. The non-transitory computer readable storage medium storing instructions of claim 15, wherein the subsequent settings are imported from a previous vehicle of the first user.
